(19) United States
(12) Patent Application Publication
(10) Pub. No.: US 2007/0283376 A1
(43) Pub. Date: Dec. 6, 2007

(54) Disk apparatus

(75) Inventors: Takao Naito, Mito (JP); Kazuyuki Kodama, Mito (JP); Akinori Shiozawa, Yokohama (JP); Hisataka Sugiyama, Kodaira (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/698,443

(22) Filed: Jan. 26, 2007

(30) Foreign Application Priority Data
Jun. 5, 2006 (JP) 2006-155566

(51) Int. Cl. G11B 17/028; G11B 19/20

(52) U.S. Cl. 720/707; 720/717

(57) ABSTRACT

There is provided an optical disk apparatus that can inhibit, during recording or reproduction of data on or from an optical disk, a side runout that may occur in the optical disk in its circumferential direction as a result of Coriolis force when a disk rotating shift is subjected to procession movement, thereby allowing recording and reproducing quality to be stabilized and a reduced size of the apparatus. The disk apparatus provided has pressure pawls arranged at intervals smaller than those in the prior art, each of which is provided with a plurality of pressing points arranged at intervals larger than those in the prior art. Particularly, an interval between the pressure pawls is an acute angle in terms of the center angle of the disk. An interval between the pressing points is an angle of 35° or larger.

### INCORPORATION BY REFERENCE

The present application claims priority from Japanese application JP2006-155566 filed on Jun. 5, 2006, the content of which is hereby incorporated by reference into this application.

### BACKGROUND OF THE INVENTION

The present invention is in the technical field concerning disk apparatuses using disk media. Particularly, the invention relates to a disk apparatus that is suitable for reducing the occurrence of a tilt in a disk caused by procession movement in a portable optical disk apparatus such as a video camera.

Techniques for installing and fixing a removable disk in a disk apparatus are disclosed in JP-A-8-335351, JP-A-8-190754, JP-A-10-21615, JP-A-11-213498 and JP-A-7-272370.

### BRIEF SUMMARY OF THE INVENTION

In an optical disk apparatus such as a video camera, a user may roll the apparatus during rotation of an optical disk. For example, while following a child running around, the user may move the video camera in various directions. In particular, a frontward, backward, rightward, leftward, upward, or downward tilt of the video camera may cause rolling motion. Rolling may result in procession movement, which may generate Coriolis force in the optical disk. The Coriolis force generated may cause a tilt. A larger tilt may cause a problem that recording and reproducing quality is deteriorated.

Procession movement, Coriolis force and a resulting tilt will be now described taking, as an example, an optical disk camera 1 equipped with an optical disk drive.

FIG. 2 shows an example of procession movement in the optical disk camera 1. The procession movement means circular swing of the axis of rotation of an object. In the figure, an x axis, a y axis, and a z axis indicate the axis of rotation of an optical disk 2, the axis of rotation observed when the camera is rotated over sideways, and the axis of rotation observed when the camera performs a pan operation respectively.

Photographing with the optical disk camera 1 involves various rolling motions of the optical disk camera. The rolling motions are classified into a vertical swing operation (x-axis rotating direction), a sideways rotating operation (y-axis rotating direction), a horizontally swinging pan operation (z-axis rotating direction), and the like. Among these operations, when the optical disk 2 rotating at an angular speed θx with respect to the x axis is moved so as to create rotating components of angular speeds θy and θz with respect to the y and z axes, the optical disk 2 starts procession movement and is subjected to Coriolis force. The Coriolis force is a kind of inertia force exerted on an object moving on a rotating coordinate system, in a direction perpendicular to the moving direction of the object, the inertia force having a magnitude proportional to the movement speed. In the present example, description will be made on the premise that the rotating coordinate system corresponds to rotation of the optical disk camera (in particular, θy and θz), the object corresponds to the optical disk 2, and the moving direction corresponds to a circumferential direction of the optical disk (θx).

FIG. 3 shows the condition of Coriolis force exerted on the optical disk 2 and a resulting tilt when the optical disk camera 1 is rotated over sideways, that is, it is moved at the angular speed θy in the y axis direction.

When the optical disk 2 rotating at the angular speed θx with respect to the x axis 6, the axis of rotation, is moved at the angular speed θy with respect to the y axis 7, the optical disk 2 is subjected to upward Coriolis force 4 on an optical head 3 side and to downward Coriolis force 4 on the opposite side. The Coriolis force 4 tilts the optical disk 2 in a radial direction on the optical axis of the optical head 3. This tilt of the optical disk 2 causes the optical axis of the optical head 3 to be applied obliquely to the optical disk 2, which optical axis is otherwise applied perpendicularly to the optical disk 2. Consequently, an angle is formed between the optical axis of incident light and that of emitted light. This corresponds to a tilt 5 of the disk which forms an angle between the optical disk 2 and the optical axis applied by the optical head 3.

If the optical disk camera 1 performs a pan operation, that is, it is moved at the angular speed θz in the z-axis direction, the place where the Coriolis force 4 is exerted shifts through 90 degrees. This tilts the optical disk 2 in a tangential direction on the optical axis of the optical head 3. A similar tilt is caused in a different tilt direction. That is, the tilt direction of the optical disk is the radial or tangential direction with respect to the optical axis of the optical head 3.

To reduce such a tilt, the entire circumference of the optical disk may be clamped by a placement surface on a turntable on the optical head side and by a chucking pulley on the opposite side, as disclosed in, for example, JP-A-7-272370. However, the technique described in JP-A-7-272370 requires the separate chucking pulley to be provided opposite the spindle motor. Further, the chucking pulley must be positioned so as not to obstruct the user's operation of installing the optical disk and must rotate integrally with a spindle motor during recording or reproduction. This requires a mechanism that allows free movement between the two positions. Accordingly, this complicates the apparatus and increases its size and cost.

Particularly in recent years, portable optical disk reproducing and display apparatuses, laptop PCs (Personal Computers), and video cameras have used optical disk drives such as DVDs (Digital Versatile Discs). Thus, there is a strong demand for a reduction in the size of the disk apparatus.

On the other hand, a self chucking scheme, which is suitable for a reduction in size, may cause a tilt. The self chucking scheme means a scheme that the user directly installs a disk on the turntable. The configuration of the self chucking scheme is described in, for example, JP-A-8-335351, JP-A-8-190754, JP-A-10-21615, and JP-A-11-213498 but poses the above problem associated with the tilt.

This problem will be described with reference to FIG. 1. FIG. 1 shows a sectional view of an optical disk apparatus based on the self chucking scheme. Also in FIG. 1, the Coriolis force 4 is exerted on the optical disk 2 as in the case of FIG. 3. The apparatus has an opening window 12 in a side surface of a cylindrical boss 13 that passes through a center hole in the optical disk 2. Pressure pawls 11 are received in the opening window 12 so that they can be projected and retracted in the radial direction 14. However, the boss need not necessarily be cylindrical but may be polygonal. The pressure pawls 11 are biased in their outer periphery directions by cushioning members (for example, coil springs or leaf springs) mounted in the cylindrical boss 13. The biasing force of the cushioning members generates pressing force 8 at the points (pressing points) where the pressure pawls 11 contact the optical disk. The pressing force 8 presses vicinity of the center hole of the optical disk 2 toward the turntable 9. The pressure pawls 11 are not limited to the pawl type but may be simple convex parts and are also called pressure portions.

Here, if Coriolis force 4a is exerted on the optical disk 2 to generate a tilt 5a in a direction away from the optical head 3 on the optical disk 2, the pressing force 8 generated at the pressure pawls or pressure portions 11 by the cushioning members, built in the boss 13, resists the Coriolis force 4a. Consequently, the magnitude of the tilt is relatively small. However, as shown in JP-A-8-335351, the self chucking scheme does not provide the pressure pawls 11 all over the circumference of the optical disk but at, for example, about three points, and the pressure pawls 11 are not present in any other areas. In the areas without the pressure pawls, no pressing force 8 is generated and resists the Coriolis force 4a. Consequently, the magnitude of a possible tilt is relatively large, for example, as shown by a dotted line. In this manner, the magnitude of the possible tilt differs between the areas with the pressure pawls 11 and the areas without the pressure pawl 11, resulting in a side runout 16 in the circumferential direction of the optical disk 2.

If the Coriolis force 4b is exerted on the optical disk 2 to cause a tilt 5b toward the optical head 3, the placement surface 10 on the turntable 9 covering the entire circumference of the optical disk 2 prevents the variation in the magnitude of a possible tilt, related to the presence or absence of the pressure pawl 11, as well as the resulting side runout.

If the pressure pawls 11 have three pressure points, the side runout 16 occurs at a period triple the rotation period of the optical disk. The large intervals between the pressure points increase the magnitude of the side runout resulted from the Coriolis force. This causes a problem that recording and reproducing quality is deteriorated.

Particularly in recent years, much attention has been paid to optical disks (BDs and the like) which read information at a shorter focal length than DVDs. Accordingly, the amount of the side runout may significantly affect the quality.

Thus, an object of the invention is to provide, for example, a disk apparatus having pressure pawls arranged at intervals smaller than those in the prior art.

Another object of the invention is to provide, for example, a disk apparatus in which pressing points of the pressure pawls are arranged at intervals larger than those in the prior art.

The above means makes it possible to suppress the side runout of the disk on the basis of procession movement, to reduce the size of the apparatus, and to inhibit an increase in costs.

The other objects, means, and effects will be apparent from embodiments which will be described below.

### BRIEF DESCRIPTION OF THE SEVERAL VIEWS OF THE DRAWING

These and other features, objects and advantages of the present invention will become more apparent from the following description when taken in conduction with the accompanying drawings wherein:

FIG. 1 is a view showing the occurrence of Coriolis force, a tilt, and a side runout in an optical disk apparatus;

FIG. 2 is a view showing rolling motion with respect to optical disk camera;

FIG. 3 is a view showing the occurrence of Coriolis force and a tilt with respect to an optical disk;

FIGS. 4A, B are views showing an example of configuration of the optical disk drive;

FIGS. 5A, B are views showing an example (1) of shape of a pressure pawl in the optical disk drive;

FIGS. 6A, B are views showing examples (2) of shape of a pressure pawl in the optical disk drive;

FIG. 7 is a view showing an example of an optical disk installed in the optical disk drive as viewed from the front;

FIG. 8 is a diagram showing an example of a gain line in accordance with DVD-RAM standards;

FIG. 9 is a view showing a model for calculating Coriolis force;

FIG. 10 is a view showing a model for calculating the deformation of a beam supported at its opposite ends when load is applied;

FIG. 11 is a diagram showing an example of the relationship between the angle between pressing points of pressure pawls and a side runout amount; and

FIGS. 12A, B are views showing an example (3) of shape of a pressure pawl in the optical disk drive.

### DETAILED DESCRIPTION OF THE INVENTION

Preferred embodiments of the present invention will be described below. However, the invention is not limited to the embodiments. For example, the invention is not limited to optical disks but is applicable to any removable disks.

### Embodiment 1

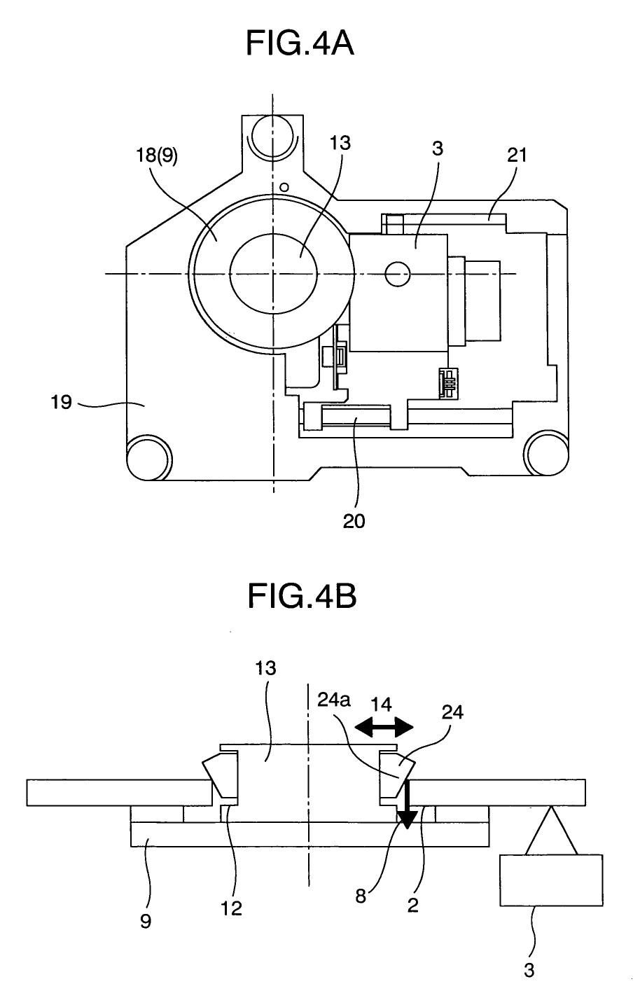

FIG. 4 shows an example of configuration of an optical disk drive as an example of an optical disk apparatus. The optical disk drive is mounted in, for example, a video camera, a PC, or a recorder comprising an image capturing section (CCD, CMOS or the like) for inputting video and a microphone for inputting sound. Video cameras, PCs, and recorders are collectively called optical disk apparatuses.

FIG. 4A is a front view of the optical disk drive, and FIG. 4B is a sectional view of the optical disk drive.

As shown in FIG. 4A, a spindle motor 18 for rotation together with the optical disk and an optical head 3 are mounted on a mechanical chassis 19. An optical head 3 is mounted on the mechanical chassis 19 via two parallel bars, a main shaft 20 and a sub-shaft 21, so as to be movable in a radial direction with respect to the optical disk. The optical head 3 is driven in the radial direction by a stepping motor (not shown).

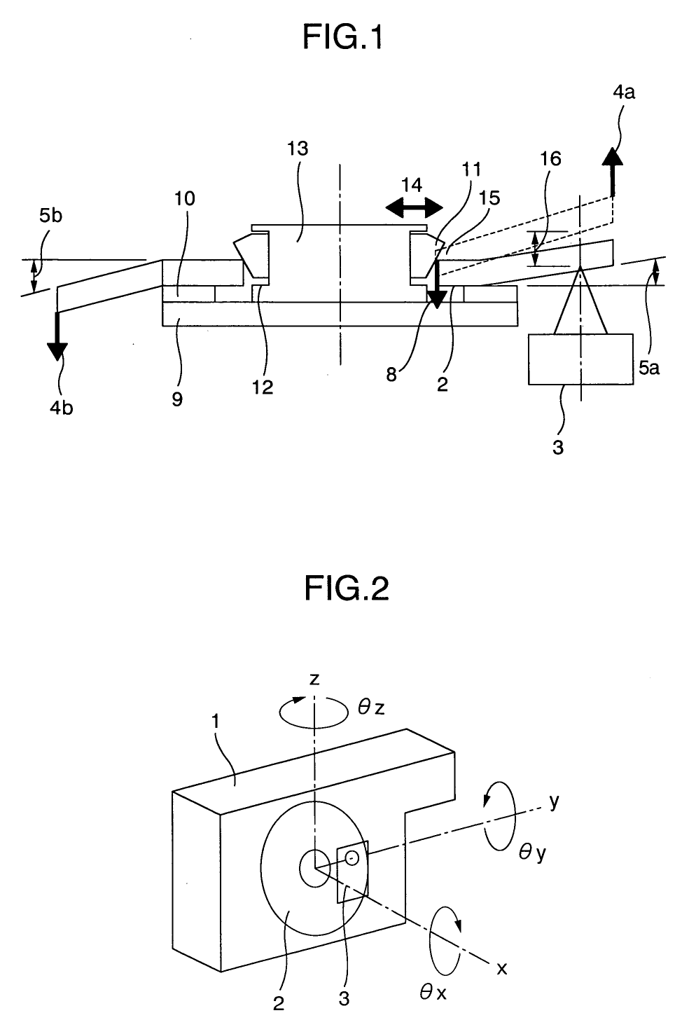

FIG. 4B is a sectional view showing the configuration around a turntable 9 of the spindle motor 18. The figure shows the condition that the optical disk 2 is pressed against a placement surface 10 on the turntable 9 in accordance with the self chucking scheme. In FIG. 4B, description on the components denoted by the same reference as those in FIG. 1 is omitted to avoid duplication. Pressure pawls in the embodiment are denoted by reference numeral 24 so as to be distinguished from the pressure pawls 11 in FIG. 1. A pressing surface of the pressure pawl 24 for the optical disk is denoted by 24a. The pressure pawls are disposed above the turntable at three positions at uniform angles and are held in a state capable of projecting and retracting in the radial directions and in a state of being biased towards their outer periphery side by cushioning members. A user installs the optical disk on the turntable while using a center hole in the optical disk to push the pressure pawls toward their inner periphery side. Once the installation is completed, that is, with the optical disk and the turntable closely contacted with each other, the pressure pawls return to their outer periphery side owing to the biasing force of the cushioning members and press an upper edge of the center hole in the optical disk. The movement of the pressure pawls 24 in the radial directions 14 causes the biasing force of the cushioning members to also act in the radial directions 14 to bias the pressure pawls in their outer periphery directions. By forming the pressing surface 24a of the pressure pawl 24 in an inclined surface, the biasing force is converted into partial force acting in the direction of pressing force 8, and this enables the optical disk to be pressed. This pressing force generates frictional force between the optical disk and the turntable, and they are thus rotationally driven without slipping. Force in the radial direction 14 is also generated from the biasing force and this force acts on the optical disk in the radial direction 14. This allows pressing and centering the optical disk 2 by means of the pressure pawls 24 alone.

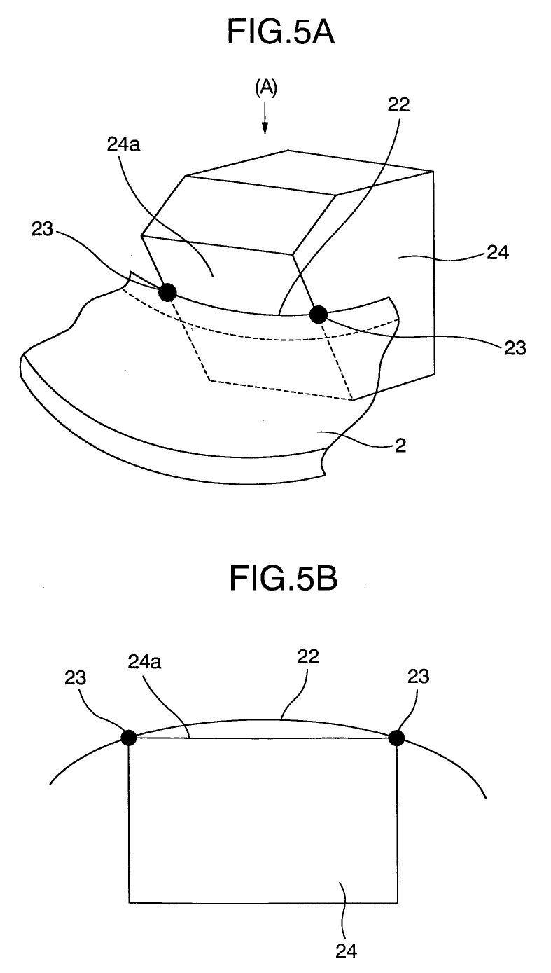

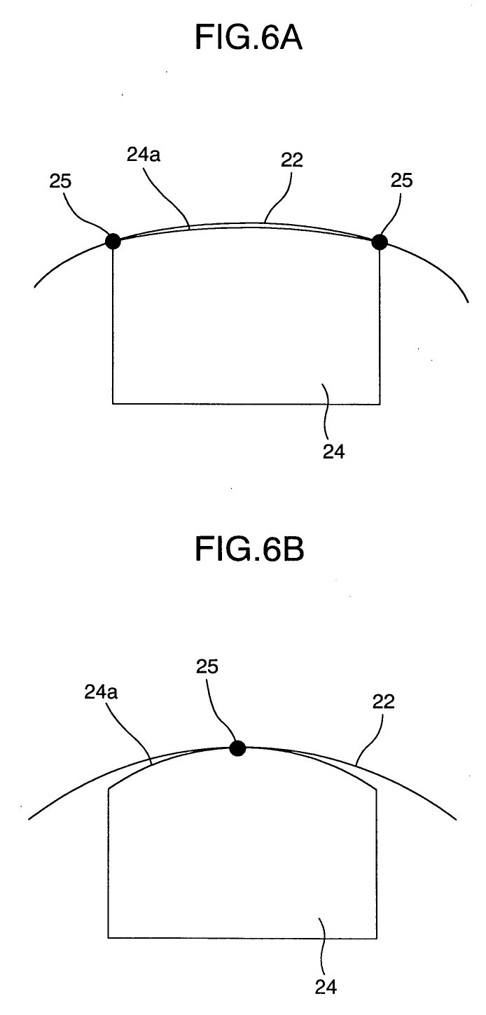

The shape of the pressure pawl 24 will be described below in detail with reference to FIGS. 5 and 6.

FIG. 5 shows an example of the pressure pawl 24, wherein FIG. 5A is a perspective view and FIG. 5B is a sectional view as seen from above in a direction (A) shown in FIG. 5A.

In this embodiment, the pressing surface 24a (inclined surface) of the pressure pawl 24 for the center hole 22 of the optical disk is made generally planar. This is to increase the number of pressing points where the optical disk center hole 22 is pressed to reduce the amount of a possible side runout caused when Coriolis force is exerted on the optical disk 2. The pressing surface 24a formed generally planar allows two opposite ends of the pressure pawl 24 to be pressing points 23 for the optical disk center hole 22 by easy processing.

The general plane will be further described with reference to FIG. 6. FIG. 6 shows sectional views of pressure pawls having circular pressing surfaces, wherein FIG. 6A is the sectional view of the pressure pawl 24 having the circular pressing surface with a radius larger than the optical disk center hole 22, and FIG. 6B is the sectional view of the pressure pawl 24 having the circular pressing surface with a radius smaller than the optical disk center hole 22.

When the pressing surface 24a is made a circular surface having the same radius as that of the optical disk center hole 22, the entire circular surface is expected to be in line contact with the inner diameter of the optical disk center surface 22. In fact, however, the dimensions of radii of the optical disk center hole 22 and of the circular surface of the pressing surface 24a may vary, and they are not necessarily in line contact.

With the ball chucking scheme shown in FIG. 6B or when the optical disk center hole 22 has a larger radius than that of the pressing surface 24a, only one point in the vicinity of the center of the pressure pawl 24 is a pressing point 25.

On the other hand, if the optical disk center hole 22 has a smaller radius than that of the pressing surface 24a as shown in FIG. 6A, the two opposite ends of the pressure pawl 24 serves as pressing points 25. This design ensures the provision of the two pressing points as shown in FIGS. 5B and 6A. Thus, the general plane is also obtained when the optical disk center hole 22 has a smaller radius than that of the pressing surface 24a.

As described above, the two pressing points provided for each pressure pawl enables an increase in the number of pressing points with a reduction in the intervals between the pressing points without increasing the number of the pressure pawls 24. This makes it possible to reduce the amount of a side runout of the optical disk caused by procession movement, to reduce the size of the apparatus, and to inhibit an increase in costs.

Although in the present embodiment the pressing surface 24a is made generally planar, any other shape may be used provided that a plurality of pressing points are ensured. For example, the pressing surface 24a may be formed in a shape concave in the radial direction or in a shape convex so as to provide three pressing points.

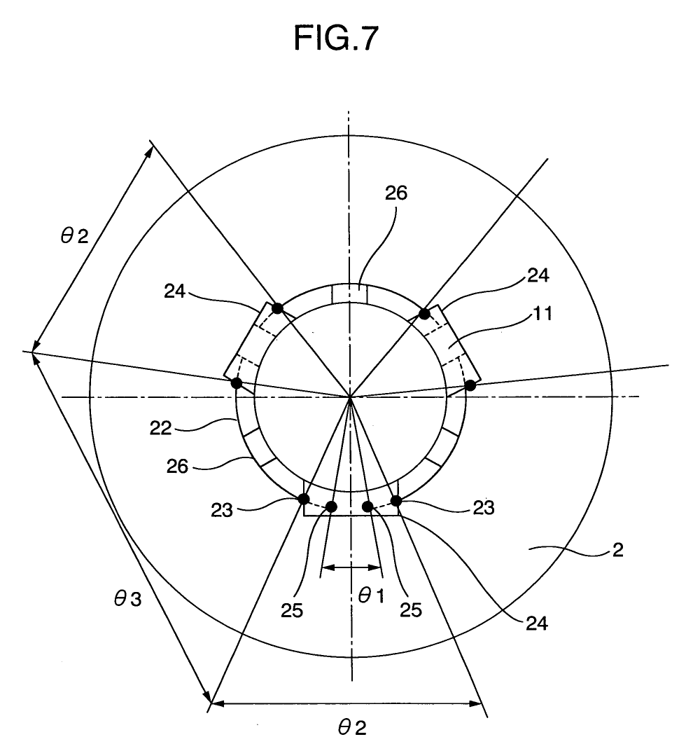

The arranging intervals between the pressing points of the pressure pawls 24 will be described with reference to FIG. 7.

FIG. 7 shows a front view of the optical disk 2 installed in the optical disk drive (as viewed from a non-data surface side of the optical disk).

In this figure, the three pressure pawls 24 received in the cylindrical boss 13 so as to be able to project and retract are provided at intervals of about 120° in terms of the center angle of the disk or turntable, and the pressing surfaces (inclined surfaces) are general planes. The three pressure pawls 24 (solid line) are so constructed that they are relatively wide and a predetermined angle θ2 (for example, 60°) is formed between the two pressing points 23 where the pressure pawls 24 press the optical disk center hole 22.

Aligning pawls 26 are for centering the optical disk 2. The three aligning pawls 26 are provided at intervals of substantially 120° and each aligning pawl is located substantially midway between the pressure pawls 24. The aligning pawls 26 are formed like leaf springs integrally with the cylindrical boss 13. Before installation of the optical disk 2, the tip of each centering pawl 26 lies outer than the optical disk center hole 22. The aligning pawls 26 work such that during installation of the optical disk 2, they are flexed by the optical disk center hole 22 and force is generated in each aligning pawl 26 to bias the optical disk center hole 22 toward the outside and to allow the optical disk 2 to be centered. The reason for separately providing the aligning pawls 26 is as follows. The pressure pawls 24 allow both pressing and centering the optical disk 2 such as a CD (Compact Disc) which is formed of a single board. However, for the optical disk 2 such as a DVD which is a laminate of two boards and in which the pressure pawls 24 bias the optical disk center hole 22 on the non-data surface side, if the two boards are laminated offset, the essential centering of the data surface may fail while the non-data surface is centered. Accordingly, the aligning pawls 26 are constructed to bring their tips in contact with the data surface side of the optical disk center hole 22. The optical disk camera in the embodiment uses DVDs as recording media and thus has the aligning pawls 26. However, if the optical disk 2 formed of a single board is used, the aligning pawls 26 need not be provided.

Now, description will be given of the fact that the optical disk is more readily flexed when the pressure pawls are provided at larger intervals. According to a dynamic model wherein a beam supported at its dynamic opposite ends is subjected to a one-point load, when the load is applied to the beam and the stiffness coefficient of the beam are constant, the flexure of the beam increases consistently with the interval between the support points. In contrast, the flexure of the beam decreases consistently with the interval between the support points. Consequently, a larger interval between the pressing points of each pressure pawl tends to increase the difference in the amount of a tilt of the optical disk caused by Coriolis force, or to increase the side runout in the circumferential direction, between the areas with the pressure pawls 11 and the areas without the pressure pawl 11.

To inhibit this trend, the interval between the pressing points of each pressure pawl 11 may be reduced. As a measure for this end, the number of pressure pawls 11 may be increased. However, this disadvantageously increases the number of parts required as well as costs. The present embodiment thus provides the plurality of pressing points on each pressure pawl without increasing the number of pressure pawls. For example, in particular, with three pressure pawls, setting θ2 at about 60° makes θ2 the same with the angle θ3 between the pressing points. This enables a further reduction in the amount of a side runout caused by the flexure of the optical disk, which occurs when Coriolis force is exerted by procession movement. Alternatively, the intervals between the pressure pawls may be set at an acute angle (not larger than 90°).

Although the present embodiment provides the three pawls and the two pressing points for every pawl, pressing points may be of three or more. In this case, comparing the arrangement in which “the pawls are arranged at intervals of 60° with the two pressure points provided for each pawl” with the arrangement in which “the pawls are arranged at intervals of 60° with three pressure points provided for each pawl”, as for the magnitude of a side runout between the pawls, the first arrangement is similar to the latter arrangement, and the magnitude of a side runout in the pawl portion is smaller in the latter arrangement. However, in fact, the shapes of the disk and pawls may vary, and all the three pressing points do not contact with the disk. For instance, there is possibility that only the central pressing point will come into contact with the disk, that is, a state similar to that shown in FIG. 6B may arise. Consequently, two pressing points are practical.

### Embodiment 2

In Embodiment 2, description will be given of conditions for θ2 in more detail, taking into account the characteristics of a servo for adjusting the amount by which the optical disk 2 is out of focus of the optical head 3. That is, θ2 is set so as to enable the magnitude of a side runout to be reduced to within the range in which the side runout can be suppressed by the servo. This makes it possible to reduce the adverse effect on the recording and reproducing quality of the DVD optical disk.

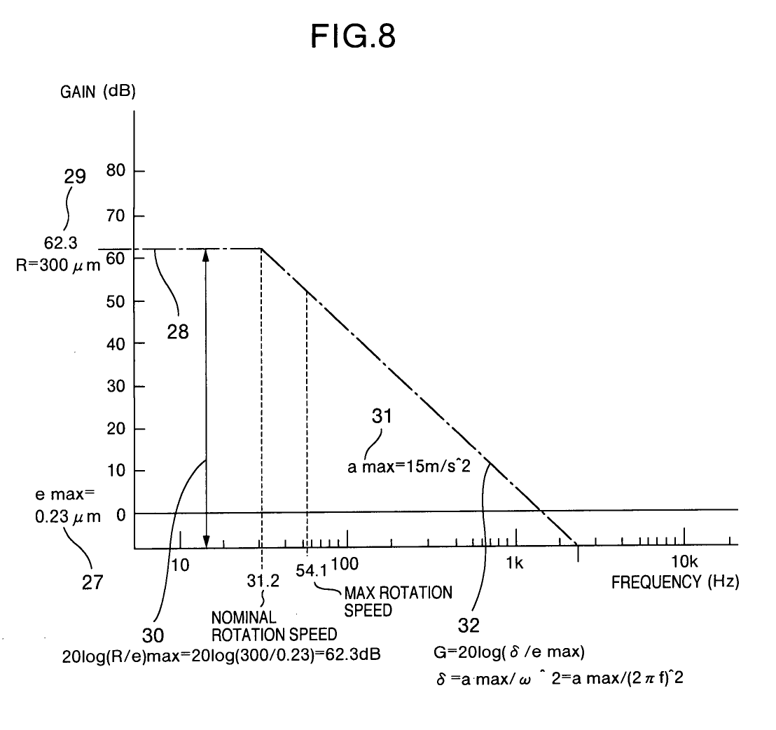

First, with reference to FIG. 8, description will be given of a servo gain required in accordance with DVD-RAM (Random Access Memory) disk standards included in ECMA (European Computer Manufacturers Association) standards. Although the description will be made on a DVD-RAM by way of example, the invention is not limited to DVD-RAMs. At the same transfer rate, DVD-RAMs rotate faster than DVD-Rs, −RWs, and +RWs are subject exposed to harsh conditions. For this reason, the DVD-RAM will be taken as an example. HD (High-Definition)-DVDs are also expected to be compatible with DVDs, and the present invention is therefore expected to be effective on the HD-DVD. Further, for example, BDs (Blu-ray Disks) have an optical spot area that is about one-fifth of that of the DVD and a track pitch width (0.32 μm) that is about half of that of the DVD. The BD is therefore expected to have a smaller focus residual error than the DVD and to have an increased rotation speed. Consequently, the present invention is thus expected to be effective on the BD

FIG. 8 shows a diagram of a gain required, in accordance with DVD standards, for optical disk apparatuses for disk evaluations. In the diagram, the axis of abscissa indicates frequency on a logarithmic scale, and the axis of ordinate indicates the logarithmic amount of gain. The gain is a value concerning the adjustment of servo voltage. The gain G (dB) is expressed by 20 log (input voltage (V)/output voltage (V)). However, the input and output may be interchanged according to the situation using them (for example, a plus sign and a minus sign are interchanged).

In FIG. 8, the focus residual error emax 27 is specified to be 0.23 μm. The focus residual error means an error in the focal length of the optical head 3 with respect to the optical disk 2 which error cannot be inhibited by the servo. A horizontal part of the gain diagram 28 (alternate long and short dash line) indicates an open loop gain (hereinafter referred to as a required gain) required to reduce the focus residual error e to emax=0.23 μm when the amount R29 of side runout of the optical disk is assumed to be 300 μm (the side runout amount of the optical disk itself+the amount of runout of the turntable). The value of the required gain is determined by substituting appropriate values into Equation 30 and is 62.3 dB. When a certain point of a closed loop is checked (for example, measured) for gain, the closed loop seems to be discontinued at this point. This is called an open loop.

$$\begin{matrix}G = 20 log ( R / e max ) \\ = 20 log ( 300 / 0.23 ) \\ = 62.3 dB\end{matrix} \qquad Equation 30$$

An inclined part indicates the gain required when a high-order fixed side runout acceleration (high-frequency side runout acceleration) amax 31 is set at 15 m/ŝ2. Equation 32 determines the gain required at each frequency. δ denotes side runout amplitude, ω denotes angular speed, and f denotes side runout frequency.

G=20 log(δ/emax) Equation 32

δ=amax/ω̂2=amax/(2πf)̂2

The gain diagrams 28 and 32 indicate the gain required when the optical head 3 is stationary and is not subjected to any disturbing vibration. In contrast, the actual design sets a margin of, for example, about +6 dB on the assumption that the optical pickup operates in the radial direction and is subjected to disturbing vibration. However, a side runout resulted from Coriolis force exerted on the optical disk is not considered. Thus, to allow the gains indicated by the diagrams 28 and 32 to be controlled by +6 dB or lower, the amount of a side runout caused when Coriolis force is exerted on the optical disk is suppressed.

Coriolis force exerted on the optical disk by procession movement is characterized by being proportional to the angular speed of the procession movement and the rotation speed of the optical disk. Thus, suppression is targeted at the amount of side runout that may occur under the worst condition for the DVD-RAM at the highest rotation speed, that is, when an angular speed is about 340 rad/s (54.1 Hz) in the most inner peripheral area zone 0 that has the maximum rotation speed. The rotation speed corresponding to the angular speed of about 340 rad/s (54.1 Hz) provides the condition of the highest rotation speed for a double-speed medium controllably rotated at a ZCLV (Zone Constant Linear Velocity). With a self chucking scheme using three pressure pawls each having one pressing point, the frequency of a side runout resulted from Coriolis force exerted on the optical disk corresponds to a period equal to triple the rotation speed of the optical disk, which is triplication of 54.1 Hz and is about 160 Hz. The gain required when the side runout frequency is 160 Hz is determined by substituting 160 Hz into the f of Equation 32. A tolerance R for the amount of a side runout when the side runout of frequency 160 Hz occurs is determined by adding 6 dB to the gain determined by Equation 32 and then by substituting the sum into the G of Equation 33 determined by Equation 30, and the tolerance is about 30 μm.

R=10̂(G/20)·emax=about 30 μm Equation 33

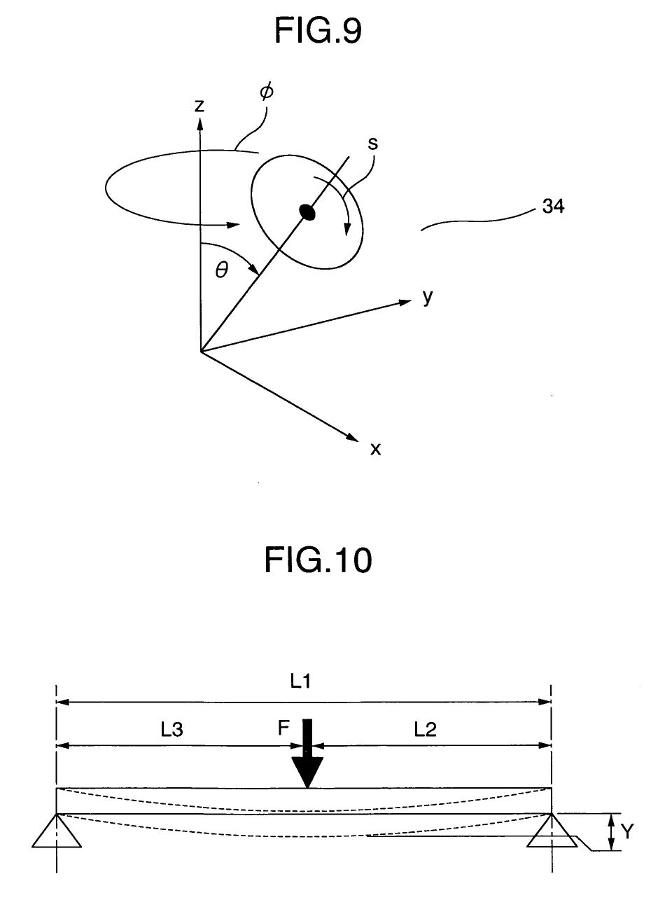

Next, description will be given of how to calculate Coriolis force exerted on the optical disk. FIG. 9 shows a reference model 34 obtained by simplifying the optical disk camera model in FIG. 2. The x, y, and z axes are the same as those in FIG. 2. Symbols used in the reference model 34 and Equation 36 are listed below.

S: 340 rad/s as described above (the rotational angular speed of the disk)

ω: rad/s (the angular speed of procession movement)

θ: 90° (in the case of the optical disk camera 1 as shown in FIG. 2)

M1: 7.2 g (the mass of an 8-cm DVD)

M2: 0.25 g (the mass of a part of the disk corresponding to its center hole)

R1: 4 cm (the radius of the 8-cm DVD)

R2: 0.75 cm (the radius of the DVD center hole)

N: Moment caused in the optical disk by procession movement

Iz: Inertia moment

F: Coriolis force (exerted immediately above the center of a lens in the optical head)

R3: 2 cm (the distance from the rotational center of the optical disk to the center of the lens in the optical head)

These conditions are substituted into Equation 36 to determine the magnitude of Coriolis force exerted on the optical disk 2 immediately above the center of the lens in the optical head 3 (on the optical axis).

F=N/R3 Equation 36

N=Iz·S·ψ·sin θ

Iz=½·((M1+M2)·R1̂2−M2·R2̂2)

Now, description will be given of the amount of deformation of the optical disk caused by the Coriolis force exerted on the optical disk.

FIG. 10 shows a dynamic model illustrating the deformation of a beam when load is applied to the beam supported at its opposite ends. In determining the amount of deformation of the optical disk caused when Coriolis force is exerted on the optical disk, the above equation can be utilized by assuming the load to be Coriolis force and by assuming the beam to be an optical disk. In connection with Equation 37 for the dynamic model, Equation 38 determines the amount of deformation of the optical disk caused when Coriolis force is exerted on the optical disk.

### <Amount of Deformation When Load is Exerted on the Center of a Beam Supported at its Opposite Ends>

Y=(2·F·L2̂2·L3̂2)/(E·b·ĥ3·L1) Equation 37

L1: Distance between the support points

L2: Distance from the support point to the point of the load applied

L3: Distance from the support point to the point of the load applied

F: Load

Y: Deformation amount

E: Young's modulus

I: Sectional secondary moment

Y=(F·L2̂2·L3̂2)/(6·E·I·L1)

I=(b·ĥ3)/12 (rectangular cross section)

b: Beam width

h: Beam thickness

### <Amount of Deformation of the Optical Disk Caused by Coriolis Force>

Y=(2·K·FL2̂2·L3̂2)/(E·b·ĥ3·L1) Equation 38

L1: Distance between the pressing points of the pressure pawl (circular length immediately above the center of the lens in the optical head)

L2: 0.5L1

L3: 0.5L1

F: Coriolis force

Y: Deformation amount of the optical disk

E: Young's modulus of the optical disk=about 2,300 MPa

b: Optical disk width=32.5 mm

h: Optical disk thickness=1.2 mm

K: Coefficient

The coefficient K is given to allow the use of Equation 37 and is the value experimentally determined because the equation cannot be used as it is due to the circular shape of the optical disk in contrast to a linear shape of the beam. Further, Equation 37 indicates that the largest deformation amount is given when the load is applied halfway between the opposite support points. Thus, Equation 38 assumes that Coriolis force is exerted halfway between the two pressing points to determine the largest deformation amount.

In a self chucking scheme using three pressure pawls each having one pressing point, the maximum angular speed of procession movement for the case where the amount of a side runout of frequency 160 Hz is within about 30 μm calculated by Equation 33 is determined to be about 3.4 rad/s through a back calculation according to Equation 36 and 38. This means that even the self chucking scheme using the three pressure pawls each having one pressing point does not affect recording and reproducing quality provided that the angular seed of procession is at most about 3.4 rad/s.

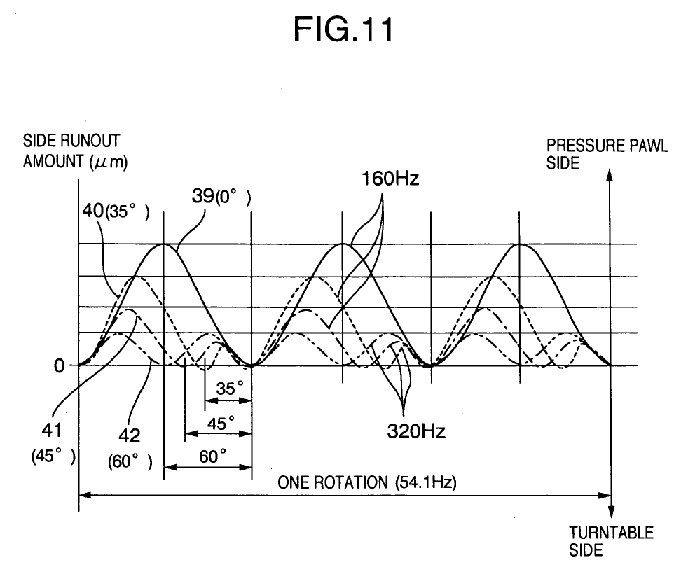

FIG. 11 shows a schematic diagram of the relationship between the angle of the pressing points of a pressure pawl and a side runout amount. With reference to the schematic diagram of FIG. 11, description will be given of the relationship among the angle between the two pressing points and the side runout amount and frequency.

In FIG. 11, a waveform 39 (solid line) is observed when each pressure pawl has one pressing point. A waveform 40 (dotted line) is observed when the angle θ2 between the two pressing points of the pressure pawl is 35°. A waveform 41 (alternate long and short dash line) is observed when the angle θ2 between the two pressing points of the pressure pawl is 45°. A waveform 42 (alternate long and two short dash line) is observed when the angle θ2 between the two pressing points of the pressure pawl is 60°. In these waveforms, the position where a side runout amount is 0 corresponds to the pressing point of the pressure pawl. For the waveforms 41 and 42, the larger waveform indicates a side runout of frequency 160 Hz, whereas the smaller waveform indicates a side runout of frequency 320 Hz.

Thus, the side runout amount decreases as the angle between the two pressing points varies from 0° to 60°. The decrease in side runout amount increases a margin for the servo, and therefore the durability against procession movement is enhanced. More specifically, the waveforms indicate that the conventional pressure pawl 11 has a waveform of a triple period, that is, a waveform of frequency 160 Hz as well as the maximum side runout amount. It is known that increasing the angle θ2 between the pressing points of the pressure pawl reduces the amount of side runout of frequency 160 Hz, while instead increasing the amount of side runout of frequency 320 Hz. When the angle θ2 between the pressing points of the pressure pawl is 60° (equal intervals), in a six-fold period, that is, a frequency of 320 Hz, the side runout amount is the minimum. Setting the angle θ2 to 60° or more results in the opposite phase and the reduced intervals between the pawls. This increases the angle between the pressing points of each pressure pawl to increase the side runout amount again.

However, only the physical side runout is minimized at 60°, and inhibition based on the servo depends not only on the side runout amount but also on the side runout frequency. Even when the side runout amount is minimized, if the side runout frequency is high, this makes the inhibition based on the servo difficult. Equations 32 and 33 indicate that the more a side runout frequency is high, the more the amount of side runout that can be inhibited by the servo is reduced (in other words, a lower side runout frequency allows the side runout to be easily inhibited). For example, a side runout amount of about 30 μm at 160 Hz calculated by Equation 33 corresponds to a side runout amount of 7.5 μm at 320 Hz (in the case of more pressure points arranged at equal intervals, the side runout amount needs to be more sharply reduced).

To allow the side runout to be inhibited by the servo, appropriate values are substituted into Equations 36 and 38 for each of 160 Hz and 320 Hz to determine the maximum angular speeds. Then, for the smaller values, the maximum angular speed is about 9.7 rad/s at θ2=35°, about 14 rad/s at θ2=45°, and about 6.9 rad/s at θ2=60°. All these values exceed the maximum angular speed of 3.4 rad/s achieved with the pressure pawls each having one pressing point, indicating a high resistance.

Further, it has been found that the maximum angular speed is maximized when the angle θ2 is substantially 45° and decreases regardless of whether the angle increases or decreases, or the durability against the precession movement is decreased. Specifically, when the angle θ2 is about 45° (according to the above equations, exactly 46.4°), the maximum angular speed at 160 Hz is substantially equal to that at 320 Hz. When the angle θ2 is larger than 45°, the maximum angular speed at 320 Hz decreases. When the angle θ2 is smaller than 45°, the maximum angular speed at 160 Hz decreases. Thus, the maximum angular speed is maximized when the angle θ2 is close to 45°. From the above, the present embodiment uses a preferable value of at least 35° and at most 600 for θ2 in order to enhance the durability against procession movement considering the angular speed of procession movement in practical use, a variation in rigidity among optical disks, etc.

### Embodiment 3

In Embodiments 1 and 2, it has been described that each pressure pawl has two pressing points and the pressure pawl is widened to increase the angle between the two pressing points to inhibit a possible side runout resulted from Coriolis force exerted on the optical disk, thereby enhancing the durability against procession movement. Now, description will be given of a technique for bringing the pressure pawl into line contact with an optical disk center hole.

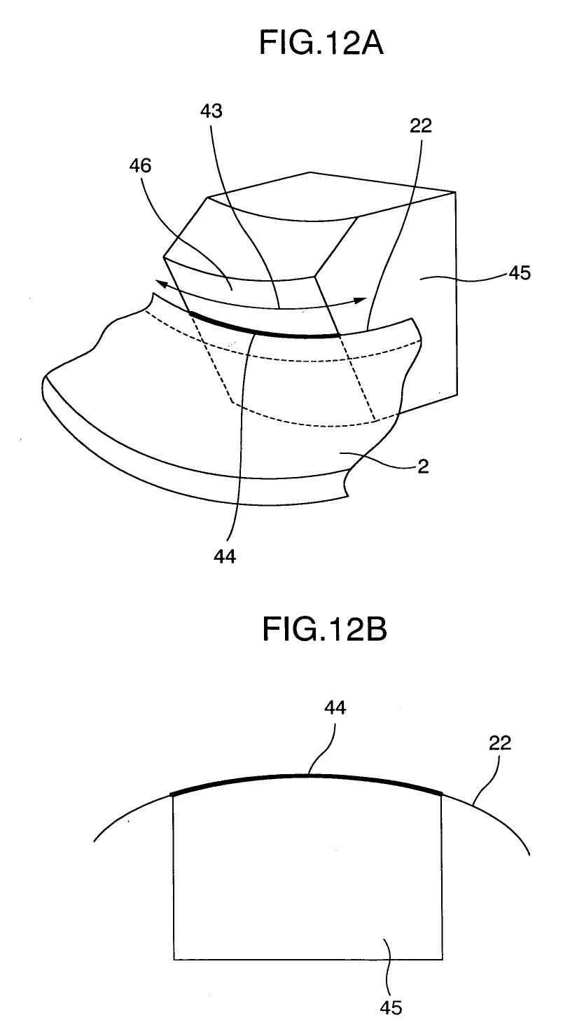

FIGS. 12A and 12B show a perspective view and a sectional view of a pressure pawl 45, respectively. The pressure pawl 45 has a pressing surface 46 that is in a circular arc shape in a circumferential direction 43 (the direction of an arrow), in which the radius of the circular arc is substantially the same as that of the optical disk center hole 22. The pressure pawl 45 is composed of an elastic member so that a pressing portion 44 comes into line contact with the optical disk center hole 22 in the circumferential direction 43 (the direction of the arrow). The elastic member is, for example, rubber or soft plastic.

Thus, even with a variation in the radii of the optical disk center hole 22 and pressing surface 46, the pressing portion 44 of the pressure pawl 45 is elastically deformed to follow the optical disk center hole 22. This ensures that the optical disk center hole 22 comes into line contact with the pressing surface 15 at the pressing portion 44 as shown in FIG. 12B. Consequently, in this embodiment, the pressing portion 44 pressed by the pressure pawl 45 is not subjected to a significant side runout when Coriolis force is exerted. Further, the portion pressed by the pressure pawl 45 is in line contact, having a further effect of inhibiting a side runout even when the angle between the two opposite ends of the pressure pawl 45 is larger than 60°.

As described above, the embodiments allow a possible side runout otherwise caused by procession movement to be inhibited to stabilize recording and reproducing quality and to enable a reduction in the size of the apparatus.

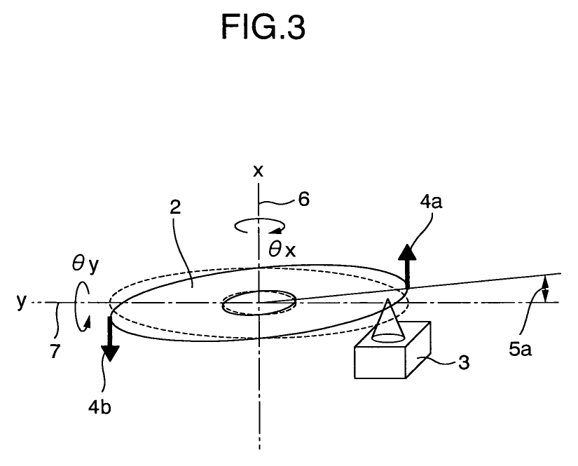

Embodiments 1 to 3 are particularly effective on Coriolis force. However, the configuration of the present embodiment is also effective on the tilt of the disk resulted from inertia (for example, inertia that may occur on the laterally opposite sides of the disk in the same direction 4a as a result of downward movement of the camera in FIG. 3) other than Coriolis force.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modification that fall within the ambit of the appended claims.

1. A disk apparatus having a turntable on which a disk is placed, a boss which is inserted in a center hole of the disk, and a plurality of pressure portions arranged on the boss to press the disk,
wherein each of the pressure portions has a plurality of pressing points where the pressure portion presses the disk, and
an interval between a first pressing point of a first one of the pressure portions and a second pressing point of a second pressure portion which is adjacent to the first point and which is different from the first pressure portion is an acute angle in terms of a center angle of the disk.

2. The disk apparatus according to claim 1, wherein the interval between the first point and the second point is an angle of 60° or smaller in terms of the center angle of the disk.

3. The disk apparatus according to claim 1, wherein an interval between the plurality of points of each of the pressure portions is an angle of 35° or larger in terms of the center angle of the disk.

4. The disk apparatus according to claim 3, wherein the interval between the plurality of points of each of the pressure portions is an angle of not smaller than 35° and not larger than 60° in terms of the center angle of the disk.

5. The disk apparatus according to claim 1, wherein the apparatus has three pressure portions separated from one another by 60° in terms of the center angle of the disk.

6. The disk apparatus according to claim 5, wherein each of the pressure potions has two pressing points.

7. The disk apparatus according to claim 1, wherein the angle of the interval between the plurality of pressure portions is, in terms of the center angle of the disk, equal to that of the interval between the plurality of pressing points on each pressure portion.

8. A disk apparatus having a plurality of pressure portions which press a disk, an interval between the pressure portions being an acute angle in terms of a center angle of the disk.

9. A disk apparatus having a plurality of pressure portions which press a disk, wherein each of the pressure portions has a plurality of pressing points where the pressure portion presses the disk, and an interval between the plurality of points of each of the pressure portions is an angle of 35° or larger in terms of the center angle of the disk.

10. A disk apparatus having a plurality of pressure portions which press a disk, wherein each of the pressure portions has a shape of a circular arc on a disk side and is comprised of a member that has elasticity in a circumferential direction of the disk.

11. The disk apparatus according to claim 1, wherein a DVD (Digital Versatile Disc)-RAM (Random Access Memory) is used as the disk.

12. The disk apparatus according to claim 1, further comprising:
an image capturing portion that inputs video; and
a microphone that inputs sound.
